(19) United States
(12) Patent Application Publication
(10) Pub. No.: US 2004/0169085 A1
(43) Pub. Date: Sep. 2, 2004

(54) Card for use in the event of accidents

(76) Inventor: Trond Morten Trondsen, Oslo (NO)

Correspondence Address: CHRISTIAN D. ABEL, ONSAGERS AS, POSTBOKS 6963 ST. OLAVS PLASS, NORWAY, N-0130, NO

(21) Appl. No.: 10/471,642

(22) PCT Filed: Mar. 15, 2002
(86) PCT No.: PCT/NO02/00108

(30) Foreign Application Priority Data
Mar. 16, 2001 (NO) 20011370

(51) Int. Cl. G06K 19/00

(52) U.S. Cl. 235/487

(57) ABSTRACT

A card for use in the event of accidents and attachment to an injured person. The card comprises a main part (2), which may bear information concerning the degree of urgency for treatment and possibly a treatment priority for the person. An area (20) of the main part (2) is movably connected to a piece (22). The piece (22) and the area (20) have portions (26, 28, 32, 34), which can be caused to overlap one another. Furthermore, sides (41, 42, 43, 44) of the area (20) and/or the piece (22) may be released in turn on movement of the piece (22) relative to the area (20), where a released side bears the information that is relevant.

The invention relates to a card for use in the event of accidents as indicated in the preamble of claim 1.

It is known from previous experience that a paramedic arriving at the scene of an accident, in which a great many people have been injured, first attempts to obtain an overview of the extent of the injuries. In this task it is vital that a plan and sequence for handling and treatment of the victims should be set up as quickly as possible, since the resources existing at the scene of the accident may prove to be inadequate for providing immediate treatment to all the injured. In this connection the victims are examined very quickly and then provided with either a green, yellow or red label in order to indicate how urgent the need for treatment is for each of the injured persons. The labels may, for example, be equipped with an adhesive that can be attached to the injured people's clothes. A red label may indicate the most urgent need, a yellow label indicates that treatment may be delayed, and a green label indicates that treatment must be delayed. In addition, the labels may be equipped with an easily legible inscription corresponding to the colour coding. This colour/text coding corresponds to a coding according to an international agreement. By means of this arrangement, therefore, a grading of the urgency for treatment can also be achieved and the injured persons may be given a treatment ranking or priority in relation to one another.

It is also known that after the first assessment of the injured persons has been performed, a closer medical examination may be performed of the injured persons in turn, and that a card, a so-called injury card is attached to the victims. This card contains a number of spaces or columns, in which the result of the examination can be systematically entered. The card also contains columns, in which a code indicating the above-mentioned degree of urgency and priority of treatment may be entered.

This card, however, is encumbered by the following disadvantages.

In the first place, filling out this card manually can be both difficult and time-consuming, particularly if the weather is bad, which is not unusual at accident scenes. The cold too can make the filling out process difficult.

Secondly, it may turn out that the degree of urgency for treatment may be assessed to be different to that which was first established and entered on the card after a new examination of the injured person. The information first entered in the column concerned must then be erased, e.g. by crossing out the text in the column, and a new text indicating the new degree of urgency for treatment must be entered. In addition to the difficulties of entering information as mentioned above, the crossing out may make the new information difficult to read. This delays the relief work and may have fatal consequences.

The object of the invention is to provide a device of the above-mentioned type, which substantially eliminates the above-mentioned drawbacks.

The characterising features of the invention will be apparent from the claims.

The invention will now be described in greater detail with reference to the drawing, which schematically illustrates two embodiments of a card according to the invention.

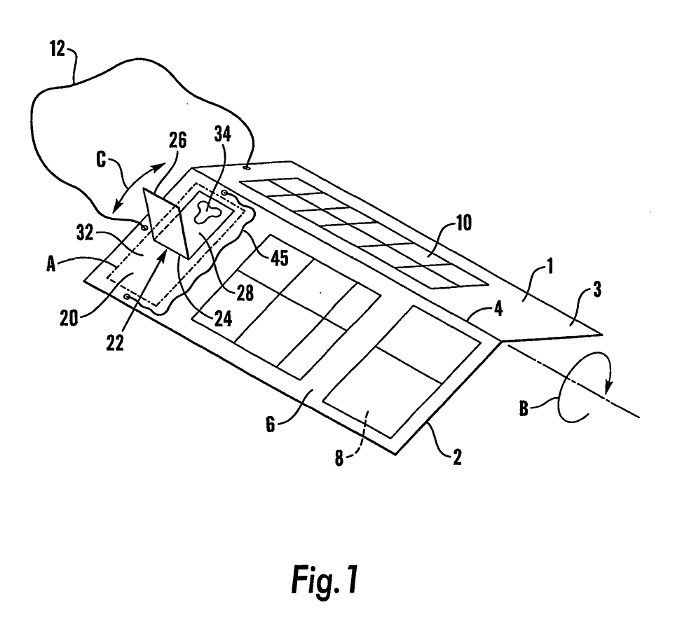

FIG. 1 is a perspective view of a first embodiment of a card with a foldable label, where a portion has been cut away.

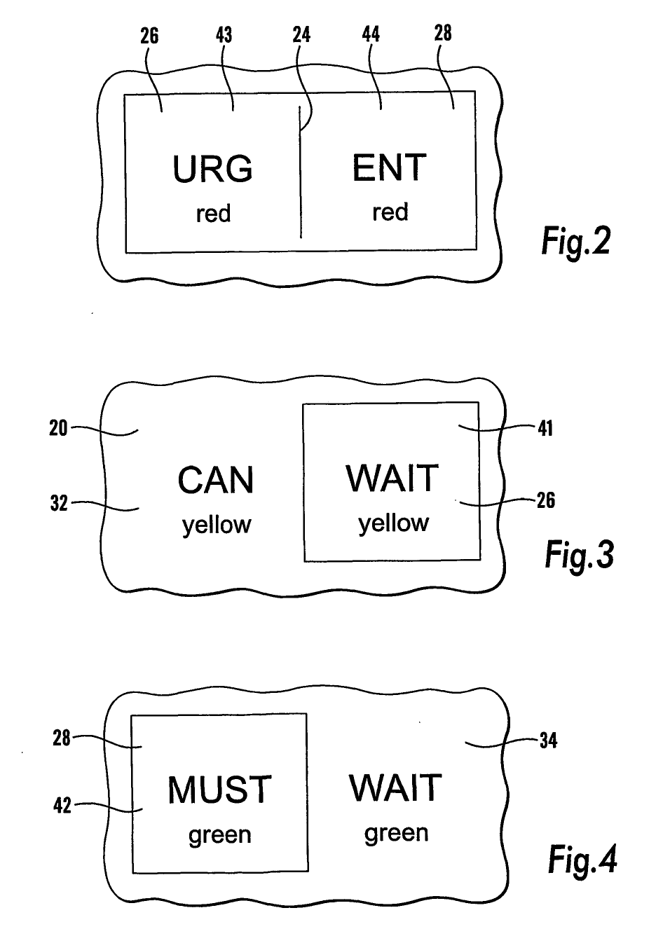

FIGS. 2-4 are views of the section which in FIG. 1 is indicated by A, where halves of the label have been moved to three different positions relative to a main part of the card.

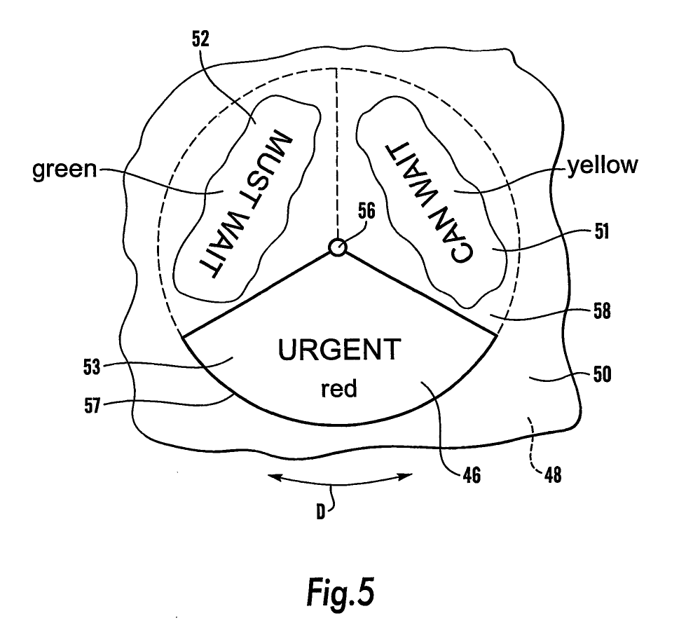

FIG. 5 is a fragmentary view of a second embodiment of the card according to the invention, where the location of the section corresponds to the location indicated by A in FIG. 1.

The terms “left” and “right” below should be understood to refer to an indication of direction or position related to the left and right sides of the figures respectively as viewed by the reader. Clockwise direction should be understood to refer to the direction of the arrow B in FIG. 1.

As illustrated in FIG. 1, a first embodiment of the card according to the invention comprises a main part 1 containing, e.g. a left half 2 and a right half 3, which can be folded in relation to each other along a fold line 4. The main part has a front side 6 and a reverse side 8. On the front side 6 columns or spaces 10 are marked off, wherein information about a person's characteristics such as condition, name, etc. can be entered. To the main part a cord 12 or the like may be attached that may, e.g., be hung round the person's neck or attached to other parts of the body, thus ensuring that the card accompanies the person if he/she is transported.

The left half 2 of the main part comprises a portion A, which is indicated in FIG. 1 by a broken line, and which in turn comprises a main part area 20 and a piece 22, which according to this embodiment is preferably flat and rectangular. The piece 22 is attached to the main part area 20 substantially along a line or fold line 24 extending parallel to two of the piece's opposite sides.

The fold line 24 divides the piece 22 into a first or left piece part 26 and a second or right piece part 28, where these piece parts 26, 28 can be folded along the fold line 24 in relation to each other and in relation to the area 20, as indicated by a double arrow C. The fold line 24 further divides the main part area 20 into a left area part 32 and a right area part 34.

FIG. 3 illustrates how the left area part 32 may be coloured yellow and have the inscription CAN.

FIG. 4 illustrates how the right area part 34 may be coloured green and have the inscription WAIT.

FIG. 3 illustrates how a first side 41 of the left piece part 26, which can be moved in such a manner that it abuts directly against the left area part 32, may be coloured yellow and have the inscription WAIT.

FIG. 4 illustrates how a second side 42 of the right piece part 28, which can be moved in such a manner that it abuts directly against the right area part 34, may be coloured green and have the inscription MUST.

FIG. 2 illustrates how a third side 43 of the left piece part 26, which faces away from the area 20 when the left piece part 26 abuts against the left area part 32, is red and has the inscription URG.

FIG. 2 illustrates how a fourth side 44 of the right piece part 28, which faces away from the area 20 when the right piece part 28 abuts against the right area part 34, is red and has the inscription ENT. Thus FIG. 2 illustrates how the piece displays the word URGENT in black letters on a red background when both piece parts have been moved in such a manner that they abut directly against the area 20.

It can be seen in FIG. 3 that the area and the piece show the words CAN WAIT on a yellow background when the left piece half 26 has been moved in a clockwise direction so that it abuts against the right piece part 28, which in turn abuts against the right area part 34.

It can be seen in FIG. 4 that the area and the piece show the words MUST WAIT on a green background when the right piece half 28 has been moved in an anticlockwise direction so that it abuts against the left piece part 26, which in turn abuts against the left area part 32.

Thus by means of a simple movement of the piece halves 26, 28, the degree of urgency for treatment can be altered without the use of a writing implement, while a colour coding is obtained in accordance with this degree of urgency for treatment.

In order to secure the piece halves in the desired positions thereof, the two ends of an elastic cord 45 can be attached on each side of the piece 22. In an uninfluenced state the cord runs in a straight line over the piece 22. When one of the piece parts 26, 28 has to be moved, the cord 45 is pulled away from the piece 22. The piece part concerned is then moved, whereupon the cord is once again permitted to run over the piece 22, securing it in the new position. Instead of an elastic cord 45, a person skilled in the art will appreciate that other means may be employed for securing the piece parts, such as a clamp, an adhesive coating that permits the piece part to be released repeatedly, or the like.

FIG. 5 illustrates a second embodiment of a card according to the invention, where a portion of the card is illustrated corresponding to the portion A illustrated in FIGS. 1-4.

FIG. 5 illustrates how a piece 46 in the form of a circular disc, is attached to the reverse side 48 of an area 58 of the left half 50 of the card's main part by means of, e.g., a rivet 56, which extends through the piece's central portion and a portion of the area 58, thus enabling the piece 46 to be rotated relative to this half 50.

The side of the piece 46 that faces the half 50 is divided into three sectors 51, 52, 53 coloured yellow, green and red respectively, and these sectors have the inscription CAN WAIT, MUST WAIT and URGENT respectively.

In the left half 50 there is provided a window 57 approximately in the form of a circular sector corresponding to one of the above-mentioned sectors of the piece 46. Thus by means of rotation of the piece 46 any of the piece's sectors 51, 52 or 53 can be brought into the window 57.

In this embodiment too a device may be provided that causes the relative position of the piece 46 and the half 50 to be secured after the piece has been rotated to a desired position. Between a head of the rivet and the card half 50, therefore, a spring disc or the like may be mounted to ensure an adequate amount of friction between the piece and the half. Another possibility is to mount a device on the underside of the card half that provides such friction. A catch device may also be mounted where the piece bears a catch half, which may be brought into engagement with a catch half of the card half when the piece has been brought into a position wherein one of the piece's sectors is located in the window.

With this second embodiment of the card according to the invention too a simplified mode of operation and reliable indication or identification are achieved.

Instead of the piece being in the form of a circular disc, which can rotate about its centre, the piece may be rectangular (not shown), comprising three rectangular spaces, which have the above-mentioned inscription, and which are arranged linearly in a row. In the main part there may be provided a window, which in form and size corresponds to one of these spaces. By means of a linear movement of the piece in its plate or sheet plane relative to the main part, a desired space can be brought into view in the window. The main part can hereby comprise rebates, wherein the piece can be moved and whereby the piece can be secured after it has been moved.

1. The use of a card comprising
a main part (2;50), where
an area (20;58) of the main part (2;50) is movably connected to a piece (22;46), and
the piece and possibly the area bear written information,
the piece (22;46) and the area (20;58) have portions (26,28,32,34;51,52,53,56), which can be caused to overlap one another, and
lateral surfaces (41,42,43,44;51,52,53) of the area (20;58) and/or the piece (22;46) can be released in turn on movement of the piece (22;46) relative to the area (20;58), and
the released side bears the information, in the event of accidents, where the information concerns the degree of urgency for treatment and possibly a treatment priority for injured persons.
